(19) United States
(12) Patent Application Publication
(10) Pub. No.: US 2026/0208662 A1
(43) Pub. Date: Jul. 23, 2026

(54) LAMP CONTROL SYSTEM, LAMP CONTROL METHOD, AND MOVING OBJECT

(71) Applicant: HYUNDAI MOBIS CO., LTD., Seoul (KR)

(72) Inventor: Jun Young SUNG, Yongin-si (KR)

(73) Assignee: HYUNDAI MOBIS CO., LTD., Seoul (KR)

(21) Appl. No.: 19/314,464

(22) Filed: Aug. 29, 2025

(30) Foreign Application Priority Data
Jan. 22, 2025 (KR) 10-2025-0009302

(51) Int. Cl. B60Q 1/14; B60Q 1/08

(52) U.S. Cl. CPC B60Q 1/143; B60Q 1/085; B60Q 2300/14; B60Q 2300/20

(57) ABSTRACT

A lamp control system for a moving object includes a lamp to emit a beam pattern, and a processor to enhance a central light amount or light width of the beam pattern based on a visibility enhancement condition of the lamp. The visibility enhancement condition is related to at least one of a set destination of a navigation system of the moving object, information related to a status of a passenger in the moving object, and information related to an infotainment function of the moving object. The processor controls the lamp to emit the beam pattern without enhancing the central light amount or light width of the beam pattern when the visibility enhancement condition is not satisfied.

### CROSS-REFERENCE TO RELATED APPLICATIONS

Pursuant to 35 U.S.C. § 119 (a), this application claims the benefit of earlier filing dates and right of priority to Korean Application No. 10-2025-0009302, filed on Jan. 22, 2025, the contents of which are hereby incorporated by reference herein in their entirety.

### BACKGROUND

### Field

The present disclosure relates to a lamp control system, a lamp control method, and a moving object, and more particularly, to a lamp control system, a lamp control method, and a moving object configured to enhance a beam pattern of a lamp.

### Discussion of the Related Art

A low beam of a lamp is one of lighting modes used in a vehicle headlight, and is a light source optimized for illuminating close distances. A main function of the low beam is to ensure a field of vision of a driver during night driving or in a dark environment, while at the same time minimizing glare to oncoming vehicles or drivers of vehicles in front.

A light pattern for a low beam is designed to have a clear upper edge of light and not blind oncoming vehicles.

A high beam of the lamp is mainly used to illuminate the road brighter and further when driving at night. The high beam emits a stronger light than a regular low beam and is effective in a certain condition. However, there are legal restrictions on the use of high beams as the high beams cause glare to other drivers. Recently, technology has been used to automatically adjust high beams by detecting headlights and taillights of vehicles ahead or oncoming vehicles by using camera sensors.

As such, lamps for vehicles are used to ensure visibility ahead.

However, with the advancement of lamp and vehicle surrounding sensing technology, methods have been proposed to automatically control low beams or high beams under a wider range of conditions, such as technology to automatically adjust high beams.

An object of the present disclosure is to provide a method of enhancing a beam pattern of a lamp in relation to a state of a user, driver or passenger of a car or vehicle or a state of use of a function of the car or vehicle.

### SUMMARY

An object of the present disclosure is to provide a lamp control system configured to control a light amount of a lamp, a moving object including the lamp control system, or a method therefor.

An object of the present disclosure is to provide a lamp control system configured to enhance a beam pattern of a lamp based on a state of a driver, driver or passenger of a car or moving object, or a state of functional use of the car or moving object when performing lamp control, a moving object including the lamp control system, or a method therefor.

The objects of the present disclosure are not limited to the objects described above. Other objects not described above may be understood by those of skill in the art from the description of the present disclosure below.

According to an embodiment of the present disclosure, a lamp control system for a moving object includes a lamp configured to emit a beam pattern, and a processor configured to enhance a central light amount or light width of the beam pattern based on a visibility enhancement condition of the lamp, wherein the visibility enhancement condition is related to at least one of a set destination of a navigation system of the moving object, information related to a status of a passenger in the moving object, and information related to an infotainment function of the moving object, and the processor is configured to control the lamp to emit the beam pattern without enhancing the central light amount or light width of the beam pattern when the visibility enhancement condition is not satisfied.

Additionally or alternatively, the processor may be configured to enhance the central light amount or light width of the beam pattern based on that the set destination of the navigation system for the moving object is not a predetermined location.

Additionally or alternatively, the processor may be configured to enhance the central light amount or light width of the beam pattern based on that there is a passenger other than a driver in the moving object, and control the central light amount or light width of the beam pattern to be greater or wider as a number of passengers in the moving object increases.

Additionally or alternatively, the processor may be configured to enhance the central light amount or light width of the beam pattern when hands-off, which is a state in which the driver of the moving object does not hold a steering wheel, is detected, and control the central light amount or light width of the beam pattern to be greater or wider as an amount of time in which the hands-off is maintained increases.

Additionally or alternatively, the processor may be configured to enhance the central light amount or light width of the beam pattern when a driver of the moving object is in a drowsy state, and control the central light amount or light width of the beam pattern to be greater or wider as an amount of time in which the drowsy state is maintained increases.

Additionally or alternatively, the processor may be configured to enhance the central light amount or light width of the beam pattern based on an audio function being used through an infotainment system of the moving object, and control the central light amount or light width of the beam pattern to be greater or wider as a volume setting for the audio function of the infotainment system increases.

Additionally or alternatively, the processor may be configured to enhance the central light amount or light width of the beam pattern based on a telephone function being used through an infotainment system of the moving object, and control the central light amount or light width of the beam pattern to be greater or wider as a volume setting for a telephone function of the infotainment system increases or a usage time of the telephone function increases.

Additionally or alternatively, the processor may be configured to determine whether to initiate a mode for enhancing visibility of the beam pattern based on data or information obtained from driving data of the moving object, and the data or information obtained from the driving data of the moving object may be received from a server.

According to another embodiment of the present disclosure, a lamp control method for a moving object, which is performed by a lamp control system including a lamp configured to emit a beam pattern, includes determining whether a visibility enhancement condition of the lamp is satisfied, and enhancing a light amount or light width of the beam pattern based on a satisfaction of the visibility enhancement condition, and controlling the lamp to emit the beam pattern without enhancing a central light amount or light width of the beam pattern based on dissatisfaction of the visibility enhancement condition, wherein the visibility enhancement condition is related to at least one of a set destination of a navigation system of the moving object, information related to a status of a passenger in the moving object, and information related to an infotainment function of the moving object.

The lamp control method may include enhancing the central light amount or light width of the beam pattern when the set destination of the navigation system for the moving object is not a predetermined location.

The lamp control method may include enhancing the central light amount or light width of the beam pattern when there is a passenger other than a driver in the moving object, and the central light amount or light width of the beam pattern may be configured to be controlled to be greater or wider as a number of passengers in the moving object increases.

The lamp control method may include enhancing the central light amount or light width of the beam pattern when hands-off, which is a state in which the driver of the moving object does not hold a steering wheel, is detected, and the central light amount or light width of the beam pattern may be configured to be controlled to be greater or wider as an amount of time in which the hands-off is maintained increases.

The lamp control method may include enhancing the central light amount or light width of the beam pattern based on that a driver of the moving object is in a drowsy state, and the central light amount or light width of the beam pattern may be configured to be controlled to be greater or wider as an amount of time in which the drowsy state is maintained increases.

The lamp control method may include enhancing the central light amount or light width of the beam pattern based on an audio function being used through an infotainment system of the moving object, and the central light amount or light width of the beam pattern may be configured to be controlled to be greater or wider as a volume setting for the audio function of the infotainment system increases.

The lamp control method may include enhancing the central light amount or light width of the beam pattern to be enhanced based on a telephone function being used through an infotainment system of the moving object, and the central light amount or light width of the beam pattern may be configured to be controlled to be greater or wider as a volume setting for the telephone function of the infotainment system increases or a usage time of the telephone function increases.

The lamp control method may include determining whether to initiate a mode for enhancing visibility of the beam pattern based on data or information obtained from driving data of the moving object, and the data or information obtained from the driving data of the moving object may be received from a server.

According to another embodiment of the present disclosure, a moving object includes a lamp configured to emit a beam pattern, and a lamp control system including a processor configured to enhance a central light amount or light width of the beam pattern based on a visibility enhancement condition of the lamp, wherein the visibility enhancement condition is related to at least one of a set destination of a navigation system of the moving object, information related to a status of a passenger in the moving object, and information related to an infotainment function of the moving object, and the processor is configured to control the lamp to emit the beam pattern without enhancing the central light amount or light width of the beam pattern if the visibility enhancement condition is not satisfied.

The processor may be configured to enhance the central light amount or light width of the beam pattern when the set destination of the navigation system for the moving object is not a predetermined location.

the processor may be configured to enhance the central light amount or light width of the beam pattern when there is a passenger other than a driver in the moving object, and the central light amount or light width of the beam pattern may be configured to be controlled to be greater or wider as a number of passengers in the moving object increases.

The processor may be configured to enhance the central light amount or light width of the beam pattern when hands-off, which is a state in which the driver of the moving object does not hold a steering wheel, is detected, and the central light amount or light width of the beam pattern may be configured to be controlled to be greater or wider as an amount of time in which the hands-off is maintained increases.

The solution of the present disclosure is a part of the embodiments of the present disclosure. Various solution means other than the solution means of the above objects may be derived and understood based on the detailed description of the present disclosure to be described below.

### BRIEF DESCRIPTION OF THE DRAWINGS

The accompanying drawings, which are incorporated in and are intended to aid in the understanding of the present disclosure and are intended to illustrate embodiments of the present disclosure and, together with the detailed description, serve to explain the present disclosure.

FIG. 1 is a block diagram of an autonomous vehicle to which an autonomous driving device is applicable.

FIG. 2 is a diagram showing an example of an autonomous driving device applied to a vehicle.

FIG. 3 is a block diagram of a lamp control system according to the present disclosure.

FIG. 4 is a flowchart illustrating a method for visibility enhancement control related to a beam pattern according to an embodiment of the present disclosure.

FIG. 5 is a flowchart illustrating a method for visibility enhancement control related to a beam pattern according to another embodiment of the present disclosure.

FIG. 6 is a flowchart illustrating a method for visibility enhancement control related to a beam pattern according to another embodiment of the present disclosure.

FIG. 7 is a flowchart illustrating a method for visibility enhancement control related to a beam pattern according to another embodiment of the present disclosure.

FIG. 8 illustrates an example of a beam pattern with a controlled central light amount or light width according to the present disclosure.

### DETAILED DESCRIPTION

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In the specification, when a part “includes” an element, it means that the part may further include another element rather than excluding another element unless otherwise mentioned.

In addition, in the specification, “occupant”, “passenger”, “driver”, “user”, etc. are mentioned for description of the present disclosure, and may be used interchangeably therewith.

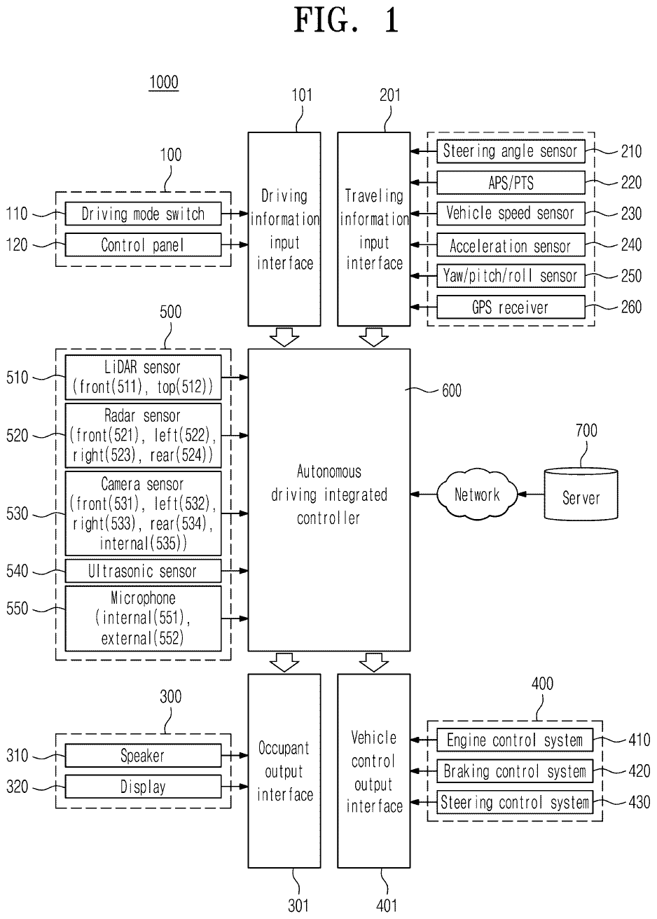

FIG. 1 is an overall block diagram of an autonomous driving control system to which an autonomous driving apparatus according to any one of embodiments of the present disclosure is applicable.

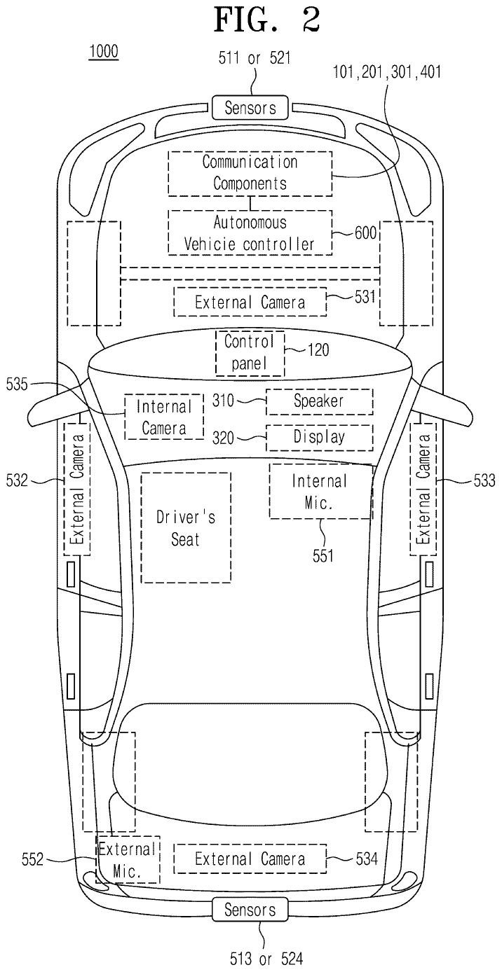

FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LIDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

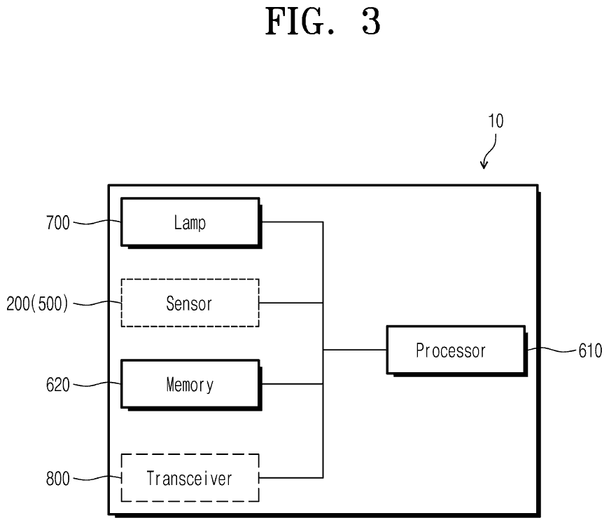

FIG. 3 illustrates a block diagram of a lamp control system according to the present disclosure.

A lamp control system 10 may include a lamp 700, a memory 620, and a processor 610. The lamp control system 10 may be included in a moving object 1000 and may be mounted or installed in the moving object 1000. In this specification, the moving object means an object that has mobility as a transportation, and may include, for example, a vehicle, a drone, and a robot.

The lamp 700 is a type of output unit that irradiates a beam in a front direction of a moving object according to a beam pattern and may be formed in a pair. In more detail, the lamp 700 may include a pair of headlamps on a left front and right front based on the moving object (or vehicle). In general, a headlamp or a headlight may include a low beam, a high beam, a turn signal, a daytime driving light, and a side light.

The lamp 700 may include a turn signal lamp, referred to as a turn signal. The turn signal lamp may output a turn signal to notify rear or oncoming vehicles, pedestrians, or the like that a moving object is about to change lanes or enter or exit a lane.

The memory 620 may be configured to store data or information obtained or analyzed from driving data of the moving object 1000. The driving data refers to data related to driving of a moving object, and may include data related to the moving object, information inside the moving object, or information outside the moving object. Data or information obtained or analyzed from the driving data stored in the memory 620 may be used for lamp control according to the present disclosure.

The memory 620 may be configured to store the following information.

### 1) Navigation Destination

The memory 620 may store navigation data of a moving object 1000. Additionally or alternatively, the memory 620 may be configured to store information about a starting point or destination of navigation of the moving object. In more detail, information about the starting point or destination may include location information of the home or workplace (company) of a user of the moving object. The location information of the home or workplace (company) of the user may be information preset by the user of the moving object.

When the moving object is used by a plurality of users (for example, when a couple shares one moving object), the lamp control system 10 may identify each user, and the user identification may be performed directly by the lamp control system 10 or by obtaining a result of identification performed by another system within the moving object. If user identification is possible, the memory 620 may be configured to store information about the starting point or destination of navigation for each user.

### 2) Information Related to Status of Passenger in Moving Object

The memory 620 may be configured to store information related to the status of passengers within the moving object. Information related to the status of the passengers in the moving object may be information obtained from the driving data of the moving object 1000.

For example, information related to the status of the passengers in the moving object may include information about whether there are passengers (i.e., co-passengers) other than the user (or driver) in the moving object 1000 and, if there are the passengers, the information related to the status of passengers may include information about the number of the passengers. The information related to the passenger status in the moving object may not only be passengers or the number of people, but may include information on a ratio of the passenger to board the entire driving. The information related to the status of the passengers within the moving object may include information on a ratio of driving in which the passengers are on the moving object, such as by location information, day of the week, weekday or weekend, week, month, year, or time zone, to the entire driving. In this specification, a ratio of a specific drive to the entire drive may be a value calculated based on time or distance.

As another example, information related to the status of the passengers within the moving object may include information about records of driving in which the user (or driver) does not hold a steering wheel, i.e., in a hands-off state. The information related to the status of the passengers within the moving object may not be limited to records of driving in a hands-off state, but may also include information on a ratio of driving in a hands-off state to the entire driving. The information related to the status of the passengers within the moving object may include information on a ratio of hands-of driving to the entire driving, such as by location information, day of the week, weekday or weekend, week, month, year, or time zone, to the entire driving.

As another example, the information related to the state of the passengers within the moving object may include information about a record of driving while the user (or driver) is drowsy. The information related to the status of the passengers within the moving object may not be limited to records of driving while drowsy, but may also include information on a ratio of driving while drowsy to the entire driving. The information related to the status of the passengers within the moving object may include information on a ratio of driving while drowsy to the entire driving, such as by location information, day of the week, weekday or weekend, week, month, year, or time zone, to the entire driving.

### 3) Information Related to Infotainment Functions of Moving Object

The memory 620 may be configured to store information related to the infotainment function of the moving object within the moving object. The information related to the infotainment function within the moving object may be information obtained by analyzing driving data of the moving object 1000.

For example, the information related to the infotainment function of the moving object may include information about the usage status of an audio function or the usage status of a telephone function.

The information related to the infotainment function of the moving object may not simply be limited to the usage status of the audio function or the usage status of the telephone function, but may also include information on a ratio of driving during the entire driving in which the audio function or telephone function is used.

The information related to the infotainment function of the moving object may include information on a ratio of driving with an audio function or telephone function during the entire driving, such as by location information, day of the week, weekday or weekend, week, month, year, or time zone from among all trips.

The information related to the infotainment function of the moving object may include information about volume settings set for each function, when the audio function is used or when the telephone function is used.

The information related to the infotainment functions of the moving object may be used to obtain information about how much (time or distance) the user has used the audio or telephone functions on the moving object and at what volume settings.

The navigation data described above, information related to the status of the passengers in the moving object, or information related to the infotainment function of the moving object may be data or information obtained or analyzed from a server. That is, the moving object 1000 or the processor 610 thereof may be configured to periodically or aperiodically transmit driving data of the moving object 1000 to the server, and the server may be configured to store or analyze the received driving data of the moving object 1000. In this case, the lamp control system 10 may be configured to receive from the server navigation data, information related to the status of the passengers in the moving object, or information related to the infotainment function of the moving object.

Additionally or alternatively, the navigation data described above, information related to the status of the passengers in the moving object, or information related to the infotainment function of the moving object may include data or information obtained or analyzed from driving data of other moving objects as well as driving data of the moving object 1000. Rather than driving data of all moving objects, data or information obtained or analyzed from driving data of the moving object 1000 or related to a user of the moving object 1000 may be included in the navigation data according to the present disclosure, information related to the status of the passengers in the moving object, or information related to the infotainment function of the moving object. Accordingly, data or information obtained from the driving data of the moving object 1000 or related to the user of the moving object 1000 may be used for lamp control of the moving object 1000.

For example, data or information obtained from driving data of a moving object in the same segment as the moving object 1000 or of a user of the same age or gender as the user of the moving object 1000 may be used for lamp control of the moving object 1000.

Additionally or alternatively, the navigation data described above, information related to the status of the passengers in the moving object, or information related to the infotainment function of the moving object may be information obtained or analyzed by the moving object 1000 or a processor included in the moving object 1000.

The navigation data, information related to the status of the passengers in the moving object, or information related to the infotainment function of the moving object obtained or analyzed from the moving object 1000 or the processor of the moving object 1000, and navigation data, information related to the status of the passengers in the moving object, or information related to the infotainment function of the moving object obtained or analyzed from an external device such as a server may be combined and used when controlling the lamp according to the present disclosure.

In more detail, before the navigation data, information related to the status of the passengers in the moving object, or information related to the infotainment function of the moving object are sufficiently collected from the moving object 1000, the lamp control system 10 may perform lamp control by using navigation data, information related to the status of the passengers in the moving object, or information related to the infotainment function of the moving object, which are obtained or analyzed by an external device such as a server. Once sufficient analysis data or information is collected from the moving object 1000, the lamp control system 10 may perform lamp control by using navigation data obtained or analyzed from the moving object 1000 or the processor of the moving object 1000, information related to the status of the passengers in the moving object, or information related to the infotainment function of the moving object.

As an example of passenger-related information in a moving object, the following data may be obtained.

TABLE 1

| Road | Time zone | Ratio of |
|---|---|---|
| section | (hours) | passengers |
| P1 | 1 to 6 | 15% |
| | 6 to 9 | 20% |
| | 9 to 14 | 55% |
| | . . . | . . . |
| P2 | 1 to 6 | 2% |
| | 6 to 9 | 10% |
| | 9 to 14 | 13% |
| | . . . | . . . |
| . . . | . . . | . . . |

As an example of information related to the usage status of the audio function of the moving object 1000, the following data may be obtained.

TABLE 2

| | Time |
|---|---|
| Road section | zone (hours) |
| P1 | 1 to 6 |
| Ratio of Non- | 6 to 9 |
| congested section | |

The processor 610 may be configured to control the beam pattern of a lamp 700 by using information stored in the memory 620.

The processor 610 may use destination information from among navigation data to control the beam pattern of the lamp. In more detail, if the destination of the navigation is not a pre-registered location, the processor 610 may be configured to determine that visibility needs to be enhanced for the user. If the navigation destination is not a pre-registered location, the destination needs to be recognized as an unfamiliar route and visibility needs to be improved to increase the concentration of the user or driver. Accordingly, the processor 610 may be configured to enhance the beam pattern of the lamp to enhance visibility. In this specification, enhancing the beam pattern means controlling at least one of the light amount, light distance, or light width of the beam pattern of the lamp to be larger.

The light amount or light width of a central portion of the beam pattern of the lamp according to the navigation destination (hereinafter referred to as “central light amount or light width”) may be set as follows.

TABLE 3

| | | Central light amount |
|---|---|---|
| | | or light width |
| | | (k = reference light |
| No. | Navigation destination | amount or light width) |
| 1 | Pre-registered locaiton | a* k |
| 2 | Location other than | b* k |
| | pre-registered location | |
| 1 | Pre-registered locaiton | a* k |

Here, a may be a value greater than 1, and b may be a value less than or equal to 1 but greater than 0.

That is, if the navigation destination is a pre-registered location, the processor 610 may be configured to increase the central light amount or light width of the beam pattern of the lamp. If the navigation destination is not a pre-registered location, the processor 610 may maintain the central light amount or light width of the beam pattern at a default value or reduce the central light amount or light width.

A driving speed of the moving object 1000 may be additionally used to control the central light amount or light width of the beam pattern of the lamp.

TABLE 4

| No. | Driving speed | a |
|---|---|---|
| 1 | Low | a1 |
| 2 | Miedium | a2 |
| 3 | High | a3 |
| . . . | . . . | . . . |

Here, a1, a2, a3 are values greater than 1, a1<a2<a3, and b1, b2, and b3 are values greater than 0 and less than or equal to 1, b1<b2<b3. That is, as the driving speed of the moving object 1000 increases, the processor 610 may be configured to control the central light amount or light width of the beam pattern of the lamp to be larger.

Additionally or alternatively, the processor 610 may utilize information related to the status of the passengers within the moving object in controlling the beam pattern. In more detail, the processor 610 may use information about whether a passenger is on board the moving object to control the beam pattern of the lamp, and for example, if the passenger is on board, the processor 610 may be configured to determine that visibility needs to be enhanced for the user. The more passengers there are, the more concentration the user or driver needs to have.

Accordingly, the processor 610 may be configured to enhance the beam pattern of the lamp to enhance visibility.

The central light amount or light width of the beam pattern of the lamp depending on whether a passenger is on board may be set as follows.

TABLE 5

| | | Central light amount |
|---|---|---|
| | | or light width |
| | Whether or not there | (k = reference light |
| No. | is a passenger | amount or light width) |
| 1 | When passenger is on board | a* k |
| 2 | When no passenger is on board | b* k |

Here, a may be a value greater than 1, and b may be a value less than or equal to 1 but greater than 0.

That is, when a passenger is on board the moving object 1000, the processor 610 may be configured to increase the central light amount or light width of the beam pattern. If there is no passenger on board the moving object 1000, the processor 610 may maintain the central light amount or light width of the beam pattern at a default value or reduce the central light amount or light width.

The number of passengers on board the moving object 1000 may be additionally used to control the central light amount or light width of the beam pattern of the lamp.

TABLE 6

| No. | Number of passengers | a |
|---|---|---|
| 1 | 1 | a1 |
| 2 | 2 | a2 |
| 3 | 3 | a3 |
| . . . | . . . | . . . |

Here, a1, a2, and a3 are values greater than 1, and a1<a2<a3. That is, as the number of passengers of the moving object 1000 increases, the processor 610 may be configured to control the central light amount or light width of the beam pattern of the lamp to be larger.

Additionally or alternatively, the processor 610 may utilize other information related to the status of the passengers within the moving object in controlling the beam pattern. In more detail, the processor 610 may utilize the hands-off state of the user or driver to control the beam pattern, and for example, in the case of a hands-off state, the processor 610 may be configured to determine that visibility needs to be enhanced for the user. Hands-off is a temporary shift of control of the moving object away from the user or driver, requiring increased concentration on the part of the user or driver.

Accordingly, the processor 610 may be configured to enhance the beam pattern of the lamp to enhance visibility.

The central light amount or light width of the beam pattern of the lamp depending on whether the lamp is in the hands-off state may be set as follows.

TABLE 7

| | | Central light amount |
|---|---|---|
| | | or light width |
| | | (k = reference light |
| No. | Hands off or not | amount or light width) |
| 1 | In case of hands off | a* k |
| 2 | If it's not hands off | b* k |

Here, a may be a value greater than 1, and b may be a value less than or equal to 1 but greater than 0.

That is, when the user or driver of the moving object 1000 is in a hands-off state, the processor 610 may be configured to increase the central light amount or light width of the beam pattern of the lamp. If the user or driver of the moving object 1000 is not in a hands-off state, the processor 610 may maintain the central light amount or light width of the beam pattern of the lamp at a default value or reduce the central light amount or light width.

A duration of the hands-off state of the user or driver of the moving object 1000 may be additionally used to control the central light amount or light width of the beam pattern of the lamp.

TABLE 8

| No. | Hands off duration | a |
|---|---|---|
| 1 | 1 minute or less | a1 |
| 2 | 3 minutes or less | a2 |
| 3 | 5 minutes or less | a3 |
| . . . | . . . | . . . |

Here, a1, a2, and a3 are values greater than 1, and a1<a2<a3. That is, as a time for which hands-off is maintained increases, the processor 610 may be configured to control the central light amount or light width of the beam pattern of the lamp to be larger.

Additionally or alternatively, the processor 610 may utilize other information related to the status of the passengers within the moving object in controlling the beam pattern. In more detail, the processor 610 may utilize the drowsy state of the user or driver to control the beam pattern, and for example, in the case of a drowsy state, the processor 610 may be configured to determine that visibility needs to be enhanced for the user.

Accordingly, the processor 610 may be configured to enhance the beam pattern of the lamp to enhance visibility.

The central light amount or light width of the beam pattern of the lamp depending on the drowsy state may be set as follows.

TABLE 9

| | | Central light amount |
|---|---|---|
| | | or light width |
| | | (k = reference light |
| No. | Whether drowsy or not | amount or light width) |
| 1 | In case of drowsy state | a* k |
| 2 | If not drowsy | b* k |

Here, a may be a value greater than 1, and b may be a value less than or equal to 1 but greater than 0.

That is, when the user or driver of the moving object 1000 is in a drowsy state, the processor 610 may be configured to increase the central light amount or light width of the beam pattern of the lamp. If the user or driver of the moving object 1000 is not in a drowsy state, the processor 610 may maintain the central light amount or light width of the beam pattern of the lamp at a default value or reduce the central light amount or light width.

A time for which the drowsy state of the user or driver of the moving object 1000 is maintained may be additionally used to control the central light amount or light width of the beam pattern of the lamp.

TABLE 10

| No. | Duration of drowsiness | a |
|---|---|---|
| 1 | 1 minute or less | a1 |
| 2 | 3 minutes or less | a2 |
| 3 | 5 minutes or less | a3 |
| . . . | . . . | . . . |

Here, a1, a2, and a3 are values greater than 1, and a1<a2<a3. That is, as the time for which drowsiness is maintained increases, the processor 610 may be configured to control the central light amount or light width of the beam pattern of the lamp to be larger.

Additionally or alternatively, the processor 610 may utilize information related to the infotainment function of the moving object in controlling the beam pattern of the lamp. In more detail, the processor 610 may use the usage status of the audio function or the usage status of the telephone function to control the beam pattern, and for example, in the case of the usage status of the audio function or the usage status of the telephone function, the processor 610 may be configured to determine that visibility needs to be enhanced for the user or driver. Due to audio volume or call volume, there is a need to increase the concentration of the user or driver.

Accordingly, the processor 610 may be configured to enhance the beam pattern of the lamp to enhance visibility.

In this specification, the usage status of the audio function means a state in which an audio signal is output through a speaker within the moving object 1000 via a radio or media function of the infotainment system of the moving object, and the usage status of the telephone function means a state in which the voice of the other party to a call (i.e., call sound) is output through a speaker within the moving object 1000 via the telephone function.

The central light amount or light width of the beam pattern of the lamp depending on whether the audio function or the telephone function is used may be set as follows.

TABLE 11

| | | Central light amount |
|---|---|---|
| | | or light width |
| | Whether audio function is enabled | (k = reference light |
| No. | or telephone function is enabled | amount or light width) |
| 1 | When using audio function or | a* k |
| | telephone function | |
| 2 | When audio function is not in | b* k |
| | use or telephone function is not in use | |

Here, a may be a value greater than 1, and b may be a value less than or equal to 1 but greater than 0.

That is, when the audio function or telephone function of the moving object 1000 is in use, the processor 610 may be configured to increase the central light amount or light width of the beam pattern of the lamp. When the audio function or telephone function of the moving object 1000 is not in use, the processor 610 may maintain the central light amount or light width of the beam pattern of the lamp at a default value or reduce the central light amount or light width.

The volume settings for the audio or telephone functions of the moving object 1000 may be additionally used to control the central light amount or light width of the beam pattern of the lamp.

TABLE 12

| No. | Set volume (size) | a |
|---|---|---|
| 1 | Level 5 or less | a1 |
| 2 | Level 10 or less | a2 |
| 3 | Level 15 or less | a3 |
| . . . | . . . | . . . |

Here, a1, a2, and a3 are values greater than 1, and a1<a2<a3. That is, as the volume settings for the audio function or telephone function increases, the processor 610 may be configured to control the central light amount or light width of the beam pattern of the lamp to be larger.

Instead of volume settings, a volume level detected through a voice sensor such as a microphone 550 in the moving object 1000 may be used to control the central light amount or light width of the beam pattern of the lamp.

A driving speed of the moving object 1000 in Table 4 may be additionally used to control the central light amount or light width of the beam pattern when controlling the beam pattern of the lamp according to the presence or absence of a passenger, the drowsy state of the user or driver, the hands-off state, the usage status of the audio function, or the usage status of the telephone function as described above.

Before the processor 610 performs visibility enhancement control related to the beam pattern of the lamp, the processor 610 may be configured to determine whether to initiate a mode for visibility enhancement related to the beam pattern of the lamp. When a mode for enhancing visibility related to the beam pattern of the lamp is initiated, the processor 610 may be configured to control an increase in the central light amount or light width of the beam pattern for enhancing visibility related to the beam pattern of the lamp. To this end, the processor 610 may check whether data or information obtained from the driving data of the moving object 1000 received from the server corresponds to a condition for initiating a mode for enhancing visibility related to the beam pattern of the lamp. For example, if a passenger occupancy ratio of the moving object 1000 described above exceeds a preset threshold, the processor 610 may determine that it is possible to initiate a mode for enhancing visibility related to the beam pattern of the lamp.

The lamp control system 10 may further include a sensor 200 or 500. The sensor may include sensors 210, 220, 230, 240, 250, and 260 configured to obtain information related to driving of a moving object or sensors 510, 520, 530, and 540 configured to obtain information about surroundings of the moving object. The current location information of the moving object 1000 may be obtained through the sensor.

The lamp control system 10 may further include a transceiver 800. The transceiver 800 may be configured to receive from a server at least one of navigation data, information related to the status of the passengers in a moving object, or information related to an infotainment function of the moving object. The transceiver 800 may be configured to transmit to the server driving data of the moving object 1000 equipped with or installed with the lamp control system 10.

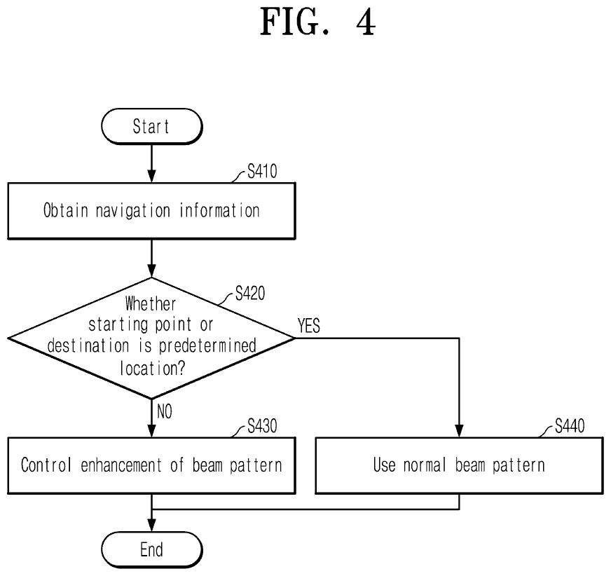

Hereinafter, with reference to FIGS. 4 to 7, a method for controlling visibility enhancement of a beam pattern according to the present disclosure will be described. In the specification below, enhancement control of a beam pattern means enhancement control of the central light amount or light width of the beam pattern. The enhancement control of the beam pattern of the illustrated lamp may be performed by the lamp control system 10 or the moving object 1000 equipped with the lamp control system 10. For simplicity of explanation, the method illustrated below is described as being performed by the lamp control system 10.

FIG. 4 is a flowchart illustrating a method for visibility enhancement control related to a beam pattern of a lamp according to an embodiment of the present disclosure.

The lamp control system 10 may be configured to determine whether a visibility enhancement condition is satisfied.

To this end, the lamp control system 10 may be configured to obtain navigation data of the moving object 1000 (S410). Then, the lamp control system 10 may be configured to check whether the starting point or the set destination from among the navigation data of the moving object 1000 is a preset specific location (S420).

The lamp control system 10 may determine that the visibility enhancement condition has been satisfied if the starting point or set destination of the navigation is not a specific location. Accordingly, the lamp control system 10 may be configured to perform enhancement control of the beam pattern of the lamp (S430).

The lamp control system 10 may determine that the visibility enhancement condition has not been satisfied if the starting point or set destination of the navigation is a specific location. Accordingly, the lamp control system 10 may be configured to use a normal beam pattern of the lamp (S430). In this specification, a normal beam pattern means a beam pattern to which visibility enhancement is not applied, and may mean a beam pattern in which the light amount or light width of the beam pattern corresponds to a reference light amount or light width.

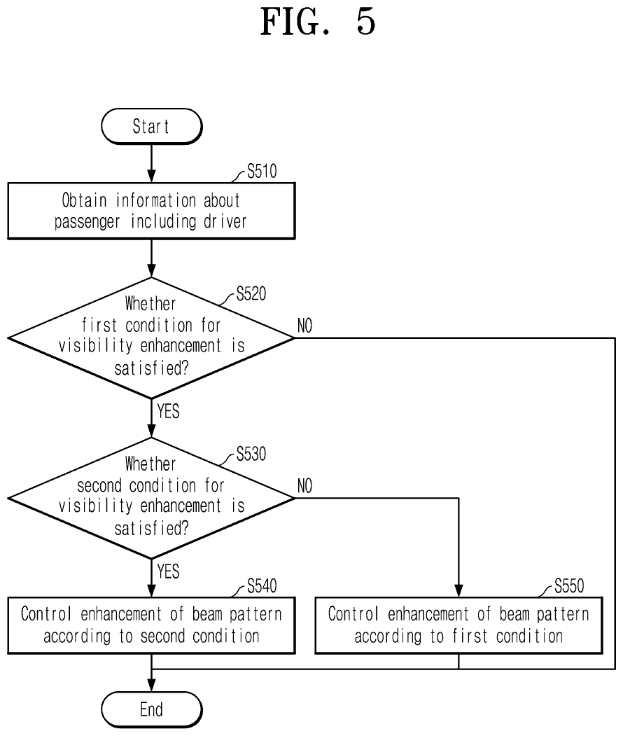

FIG. 5 is a flowchart illustrating a method for visibility enhancement control related to a beam pattern of a lamp according to another embodiment of the present disclosure.

The lamp control system 10 may be configured to obtain information related to the status of the passengers, such as a driver, in the moving object 1000 (S510).

The lamp control system 10 may be configured to determine whether the visibility enhancement condition related to a beam pattern of a lamp (hereinafter referred to as “first condition”) is satisfied based on information related to the status of the passenger such as a driver (S520). For example, satisfaction of the first condition may be determined based on at least one of the following: the presence of a passenger other than the driver, whether the driver is drowsy, or whether the driver is in a hands-off state. For example, the first condition may be determined to be satisfied if a passenger is present, the driver is drowsy, or the driver is in a hands-off state. As the first condition is not satisfied, the lamp control system 10 may be configured to terminate the visibility enhancement control.

As the first condition is satisfied, the lamp control system 10 may be configured to determine whether an additional visibility enhancement condition (hereinafter referred to as “second condition”) is satisfied (S530).

Satisfaction of the second condition may be determined based on at least one of the number of passengers, the time for which the drowsy state is maintained, or the time for which the hands-off state is maintained. That is, detailed conditions related to the first condition may be used as the second condition. If the visibility enhancement condition is satisfied in S520 due to the presence of passengers, the number of passengers in S530 becomes a reference for determining the additional visibility enhancement condition.

If the second condition is not satisfied, the lamp control system 10 may be configured to perform beam pattern enhancement control according to the first condition (S550).

If the second condition is satisfied, the lamp control system 10 may be configured to perform beam pattern enhancement control according to the second condition (S540). The beam pattern enhancement control according to the second condition may be set to a greater degree of enhancement than the beam pattern enhancement according to the first condition. For example, referring to Tables 5 and 6, the first condition may be whether there is a passenger, and the second condition may be whether there are two or more passengers. Accordingly, if there are two or more passengers, the beam pattern enhancement (i.e., a2*k, a3*k, . . . ) is performed in proportion to the number of passengers, and if there is one passenger, the basic beam pattern enhancement (i.e., a1*k) is performed.

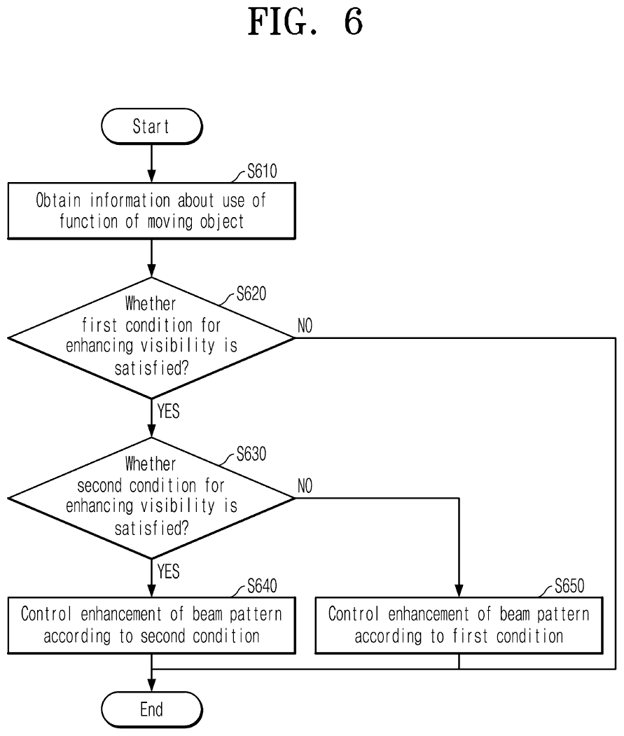

FIG. 6 is a flowchart illustrating a method for visibility enhancement control related to a beam pattern of a lamp according to another embodiment of the present disclosure.

The lamp control system 10 may be configured to obtain information related to the infotainment function of the moving object 1000 (S610).

The lamp control system 10 may be configured to determine whether the visibility enhancement condition related to a beam pattern of a lamp (hereinafter referred to as “first condition”) is satisfied based on information related to an infotainment function (S620). For example, satisfaction of the first condition may be determined based on at least one of whether an audio function through a speaker of the moving object 1000 is used or whether a call function is used. For example, if an audio signal is output from the speaker of the moving object 1000 or a call sound is output, it may be determined that the first condition is satisfied. As the first condition is not satisfied, the lamp control system 10 may be configured to terminate the visibility enhancement control.

As the first condition is satisfied, the lamp control system 10 may be configured to determine whether an additional visibility enhancement condition (hereinafter referred to as “second condition”) is satisfied (S630).

Satisfaction of the second condition may be determined based on at least one of the volume settings for the audio function or the call function. That is, detailed conditions related to the first condition may be used as the second condition. If the visibility enhancement condition is satisfied by using the audio function in S620, the volume setting for the audio function in S630 becomes a reference for determining the additional visibility enhancement condition.

If the second condition is not satisfied, the lamp control system 10 may be configured to perform beam pattern enhancement control according to the first condition (S650).

If the second condition is satisfied, the lamp control system 10 may be configured to perform beam pattern enhancement control according to the second condition (S640). The beam pattern enhancement control according to the second condition may be set to a greater degree of enhancement than the beam pattern enhancement according to the first condition. For example, referring to Tables 11 and 12, the first condition may be whether the audio function is used, and the second condition may be whether the volume setting for the audio function is greater than level 5. Accordingly, if the volume setting exceeds level 5, the beam pattern enhancement (i.e., a2*k, a3*k, . . . ) is performed in proportion to the level, and if the volume setting is level 5 or less, the basic beam pattern enhancement (i.e., a1*k) may be configured to be performed.

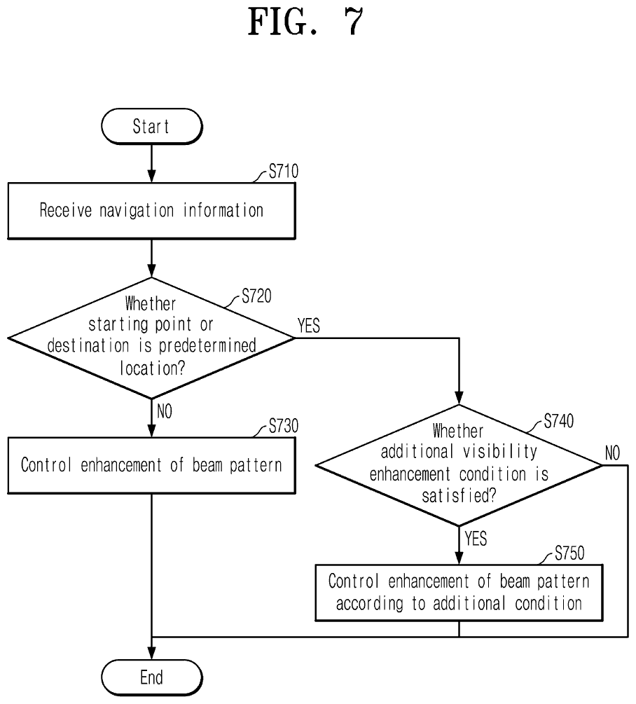

FIG. 7 is a flowchart illustrating a method for visibility enhancement control related to a beam pattern of a lamp according to another embodiment of the present disclosure.

A method for enhancing visibility control related to the beam pattern of the lamp illustrated in FIG. 7 is a method obtained by combining the method of FIG. 4 and the method of FIG. 5 or FIG. 6. Therefore, the embodiment of FIG. 7 will be briefly described, with reference to the descriptions of FIGS. 4, 5 and 6.

The lamp control system 10 may be configured to receive navigation data (S710).

If the starting point or the set destination from among the navigation data is not a preset specific location, the lamp control system 10 may be configured to perform enhancement control of the beam pattern of the lamp (S730).

With reference to FIG. 4, when the starting point or the set destination from among the navigation data is a preset specific location, a normal beam pattern is used, i.e., enhancement control of the beam pattern is not performed. However, in the embodiment of FIG. 7, the lamp control system 10 may be configured to determine whether an additional visibility enhancement condition is satisfied (S740). As additional visibility enhancement conditions are satisfied, the lamp control system 10 may be configured to perform beam pattern enhancement control according to the additional conditions (S750).

If the additional visibility enhancement conditions are not satisfied, the lamp control system 10 is configured not to perform beam pattern enhancement control.

S740 to S750 of FIG. 7 may include S510 to S550 of FIG. 5 or S610 to S650 of FIG. 6.

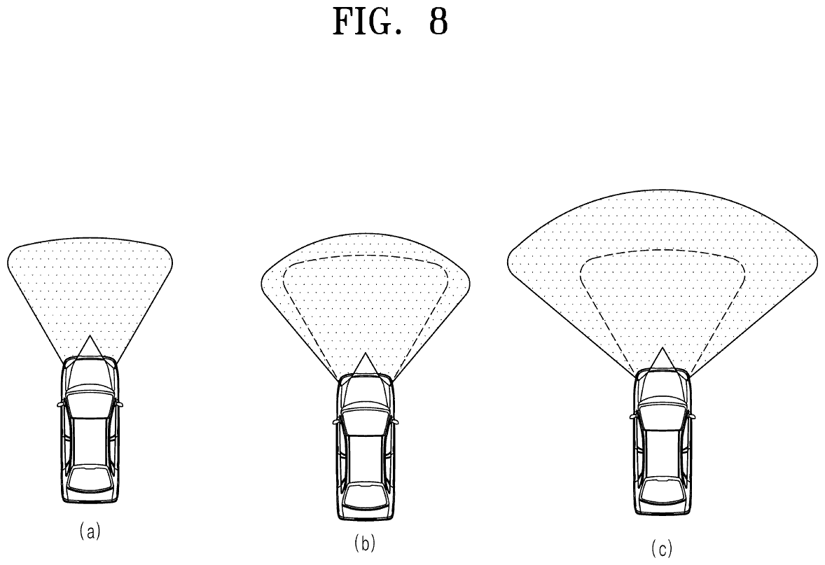

FIG. 8 illustrates an example of a beam pattern with a controlled central light amount or light width according to the present disclosure.

In the lamp control system according to the present disclosure, the beam pattern emitted from the lamp 700 may be adaptively controlled.

As an example, the beam pattern may be varied in its light amount or light width. Control for enhancing visibility related to the beam pattern of the lamp may be performed based on data or information obtained from the driving data of the moving object 1000.

(a) of FIG. 8 shows a normal beam pattern. (b) of FIG. 8 shows a beam pattern in which a light amount and light width of light at a central portion are controlled (enhanced) to a first level. (c) of FIG. 8 shows a beam pattern in which a light amount and light width of light at a central portion are controlled (enhanced) to a second level.

In FIG. 8, a total of three beam patterns are illustrated, but more or fewer beam patterns may be provided, and the beam patterns may be varied depending on specific conditions.

As illustrated in FIG. 8, the reason for enhancing or controlling the central light amount or light width is to provide improved visibility to the driver of the moving object 1000, and, when certain conditions described herein are satisfied, to form a long and wide range of light distribution to provide visibility. This may be to ensure a better view for the driver or user of the moving object 1000, or to notify the drivers or users of surrounding moving objects of (a lane change).

However, unlike as shown in FIG. 8, control of the beam pattern may include control of at least one of the light amount or light width of at the central portion.

The contents of the present disclosure described with reference to FIGS. 1 to 2 and FIGS. 4 to 8, which are not described with reference to FIG. 3, may be applied to the lamp control system 10 or the processor 610 thereof.

According to another embodiment of the present disclosure, a moving object or moving object 1000 including the lamp control system 10 described above is proposed.

In the above specification, the “system” for controlling a lamp to enhance visibility or each component included therein is described as performing control, but the “device”, “system” and the components included therein are only names and the scope of rights is not dependent on thereon.

In other words, the proposed technology of the present disclosure may be performed by devices having names other than the processor, controller, etc. In addition, the method, scheme, or the like described above may be performed by software or code readable by a computer or other machine or device for lamp control.

In addition, as another aspect of the present disclosure, the operation of the proposed technology described above may be provided as code that may be implemented, realized, or executed by a “computer” (a generic concept including a system on chip (SoC) or a (micro) processor) or a computer-readable storage medium, a computer program product, or the like storing or containing the code. The scope of the present disclosure is extendable to the code or the computer-readable storage medium or the computer program product storing or containing the code.

Detailed descriptions of preferred embodiments of the present disclosure disclosed as described above have been provided such that those skilled in the art may implement and realize the present disclosure.

Although the present disclosure has been described above with reference to preferred embodiments, those skilled in the art will understand that various modifications and changes can be made to the present disclosure set forth in the claims below.

Accordingly, the present disclosure is not intended to be limited to the embodiments shown herein but is to be accorded the widest scope consistent with the principles and novel features disclosed herein.

The present disclosure has the following effects.

The present disclosure may perform enhancement control of the central light amount or light width of the beam pattern of the lamp.

The present disclosure may improve driver visibility by enhancing the central light amount or light width of the beam pattern of the lamp.

The effects of the present disclosure are not limited to the effects described above. Other effects not described above may be understood by those of skill in the art from the description of the present disclosure below.

What is claimed is:

1. A lamp control system for a moving object, comprising:
a lamp configured to emit a beam pattern; and
a processor configured to enhance a central light amount or light width of the beam pattern based on a visibility enhancement condition of the lamp,
wherein the visibility enhancement condition is related to at least one of a set destination of a navigation system of the moving object, information related to a status of a passenger in the moving object, and information related to an infotainment function of the moving object, and
the processor is configured to control the lamp to emit the beam pattern without enhancing the central light amount or light width of the beam pattern when the visibility enhancement condition is not satisfied.

2. The lamp control system of claim 1, wherein the processor is configured to enhance the central light amount or light width of the beam pattern when the set destination of the navigation system for the moving object is not a predetermined location.

3. The lamp control system of claim 1, wherein the processor is configured to enhance the central light amount or light width of the beam pattern when there is a passenger other than a driver in the moving object, and control the central light amount or light width of the beam pattern to be greater or wider as a number of passengers in the moving object increases.

4. The lamp control system of claim 1, wherein the processor is configured to enhance the central light amount or light width of the beam pattern when hands-off, which is a state in which a driver of the moving object does not hold a steering wheel, is detected, and control the central light amount or light width of the beam pattern to be greater or wider as an amount of time in which the hands-off is maintained increases.

5. The lamp control system of claim 1, wherein the processor is configured to enhance the central light amount or light width of the beam pattern when a driver of the moving object is in a drowsy state, and control the central light amount or light width of the beam pattern to be greater or wider as an amount of time in which the drowsy state is maintained increases.

6. The lamp control system of claim 1, wherein the processor is configured to enhance the central light amount or light width of the beam pattern based on an audio function being used through an infotainment system of the moving object, and control the central light amount or light width of the beam pattern to be greater or wider as a volume setting for the audio function of the infotainment system increases.

7. The lamp control system of claim 1, wherein the processor is configured to enhance the central light amount or light width of the beam pattern based on a telephone function being used through an infotainment system of the moving object, and control the central light amount or light width of the beam pattern to be greater or wider as a volume setting for the telephone function of the infotainment system increases or a usage time of the telephone function increases.

8. The lamp control system of claim 1, wherein the processor is configured to determine whether to initiate a mode for enhancing visibility of the beam pattern based on data or information obtained from driving data of the moving object, and
wherein the data or information obtained from the driving data of the moving object is received from a server.

9. A lamp control method for a moving object, which is performed by a lamp control system including a lamp configured to emit a beam pattern, the lamp control method comprising:
determining whether a visibility enhancement condition of the lamp is satisfied; and
enhancing a light amount or light width of the beam pattern according based on a satisfaction of the visibility enhancement condition, and controlling the lamp to emit the beam pattern without enhancing a central light amount or light width of the beam pattern based on dissatisfaction of the visibility enhancement condition,
wherein the visibility enhancement condition is related to at least one of a set destination of a navigation system of the moving object, information related to a status of a passenger in a moving object, and information related to an infotainment function of the moving object.

10. The lamp control method of claim 9, further comprising enhancing the central light amount or light width of the beam pattern when the set destination of the navigation system for the moving object is not a predetermined location.

11. The lamp control method of claim 9, further comprising enhancing the central light amount or light width of the beam pattern when there is a passenger other than a driver in the moving object,
wherein the central light amount or light width of the beam pattern is configured to be controlled to be greater or wider as a number of passengers in the moving object increases.

12. The lamp control method of claim 9, further comprising enhancing the central light amount or light width of the beam pattern when hands-off, which is a state in which the driver of the moving object does not hold a steering wheel, is detected,
wherein the central light amount or light width of the beam pattern is configured to be controlled to be greater or wider as an amount of time in which the hands-off is maintained increases.

13. The lamp control method of claim 9, further comprising enhancing the central light amount or light width of the beam pattern based on that a driver of the moving object is in a drowsy state,
wherein the central light amount or light width of the beam pattern is configured to be controlled to be greater or wider as an amount of time in which the drowsy state is maintained increases.

14. The lamp control method of claim 9, further comprising enhancing the central light amount or light width of the beam pattern based on an audio function being used through an infotainment system of the moving object,
wherein the central light amount or light width of the beam pattern is configured to be controlled to be greater or wider as a volume setting for the audio function of the infotainment system increases.

15. The lamp control method of claim 9, further comprising enhancing the central light amount or light width of the beam pattern to be enhanced based on a telephone function being used through an infotainment system of the moving object,
wherein the central light amount or light width of the beam pattern is configured to be controlled to be greater or wider as a volume setting for the telephone function of the infotainment system increases or a usage time of the telephone function increases.

16. The lamp control method of claim 9, further comprising determining whether to initiate a mode for enhancing visibility of the beam pattern based on data or information obtained from driving data of the moving object,
wherein the data or information obtained from the driving data of the moving object is received from a server.

17. A moving object comprising:
a lamp configured to emit a beam pattern; and
a lamp control system including a processor configured to enhance a central light amount or light width of the beam pattern based on a visibility enhancement condition of the lamp,
wherein the visibility enhancement condition is related to at least one of a set destination of a navigation system of the moving object, information related to a status of a passenger in the moving object, and information related to an infotainment function of the moving object, and
the processor is configured to control the lamp to emit the beam pattern without enhancing the central light amount or light width of the beam pattern when the visibility enhancement condition is not satisfied.

18. The vehicle of claim 17, wherein the processor is configured to enhance the central light amount or light width of the beam pattern when the set destination of the navigation system for the moving object is not a predetermined location.

19. The vehicle of claim 17, wherein the processor is configured to enhance the central light amount or light width of the beam pattern when there is a passenger other than a driver in the moving object, and
the central light amount or light width of the beam pattern is configured to be controlled to be greater or wider as a number of passengers in the moving object increases.

20. The vehicle of claim 17, wherein the processor is configured to enhance the central light amount or light width of the beam pattern when hands-off, which is a state in which the driver of the moving object does not hold a steering wheel, is detected, and
the central light amount or light width of the beam pattern is configured to be controlled to be greater or wider as an amount of time in which the hands-off is maintained increases.
